(19) United States
(12) Patent Application Publication
(10) Pub. No.: US 2005/0006200 A1
(43) Pub. Date: Jan. 13, 2005

(54) Method for the acoustic control of bottle fill levels

(76) Inventors: Jean Gondolo, Carqueiranne (FR); Bernard Tomasini, Hyeres (FR)

Correspondence Address: HARRISON & EGBERT, 412 MAIN STREET, 7TH FLOOR, HOUSTON, TX, 77002, US

(21) Appl. No.: 10/498,388

(22) PCT Filed: Dec. 12, 2002
(86) PCT No.: PCT/FR02/04324

(30) Foreign Application Priority Data
Dec. 13, 2001 (FR) 01/16129

(51) Int. Cl. B65G 43/00; G01F 23/296; B65G 43/08

(52) U.S. Cl. 198/340; 73/290 V

(57) ABSTRACT

A method of controlling the fill level of containers involves the reflection of an acoustic signal which is emitted by an acoustic transmitter/receiver device with the device disposed above a single-line flow of containers. In the method, during an data acquisition step, one or more standard containers with a known fill level are brought under the acoustic transmitter/receiver device. After the emission of acoustic signals, the reflection signal(s) corresponding to the opening and the level of the contents in the standard container are detected. During the subsequent steps for controlling containers with an unknown fill level, the deviation(s) in the reflection signals are compared to the stored standard deviation(s), the reflection signals corresponding to the opening and the level of the contents in the container.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

This invention relates to a method for controlling the level of filling of containers by reflecting an acoustic signal transmitted by an acoustic transmitting-receiving device arranged above a single-line stream of said containers.

The invention relates to the field of manufacturing of devices aimed at ensuring the control of the state of filling, with a content, of containers in movement.

### BACKGROUND OF THE INVENTION

Various devices and various methods capable of ensuring such a control are already well-known.

The latter are, generally, adapted to the nature of the container (bottle, flask, can, canister . . . ) as well as to the nature of its content (liquid, powder . . . ).

A first solution consists in resorting to an operator in charge of performing a visual control of the level of content in the container.

To this end, said operator has to be able to distinguish clearly the level reached by the content in such a container, which makes this method inapplicable for opaque containers or containers of a particular shape.

Even if this operator is able to distinguish such a level, it does not change the fact that the visual control turns out to be particularly tedious and tiresome for this operator, especially when he has to control containers in movement, in particular at the level of a conveyor or the like.

In order to cope with such disadvantages, there exists another solution consisting in using a device operating based on the principle of weighing the container. It should be noted that such a device requires modifications in the production line and only permits a punctilious control over a small number of containers but it does not permit, at all, a continuous control over a continuous stream of containers passing at the level of a conveyor.

There are also known other controlling devices the operation of which is based on the emission and the detection of a light beam, in particular of the laser type. Such devices have a number of disadvantages connected with, on the one hand, a high cost price and, on the other hand, specific and constringent conditions of use, in particular from the point of view of the implementation and regulations.

Moreover, it should be noted, in this case too, that such devices are particularly difficult, even impossible, to be implemented in the case of opaque containers.

As mentioned above, the content of a container the filling of which should be controlled can be of various nature, this content being characterized, in particular, by its fluidity.

In this connection, it should be noted that this fluidity is likely to generate more or less considerable fluctuations of the level of filling of the container, such fluctuations being especially perceptible when the latter is in movement.

Yet, because of the presence of these fluctuations, the state-of-the-art methods and devices do not permit to proceed to an appropriate control of the level of filling of a container the content of which has a certain fluidity, in particular when this container is in movement.

In particular, these methods and devices do not permit to ensure, adequately, the control of the level of filling of a bottle containing a liquid, wine in particular, when such a bottle is in movement on a conveyor, for example between a filling stand and a corking stand for this bottle.

### BRIEF SUMMARY OF THE INVENTION

This invention pretends to be capable of coping with the above-mentioned disadvantages by means of a new method for controlling the level of filling of containers with a content.

For this purpose, this invention relates to a method for controlling the level of filling of containers by reflecting an acoustic signal transmitted by an acoustic transmitting-receiving device arranged above a conveyor including a conveying chain on which said containers are arranged, characterized in that:
during a first calibration step, one or more standard containers the level of filling of which is known are brought under said device;
after the emission of one or more acoustic signals, the reflection signal or signals corresponding to the mouth of a standard container as well as the reflection signal or signals corresponding to the level of content of this standard container are detected;
the difference or differences between these reflection signals are memorized as standard differences; and
during the subsequent steps of control of containers with an unknown level of filling, the difference or differences of the reflection signals, corresponding to the mouth and to the level of content, resulting from a signal or a series of acoustic signals transmitted by said device are compared to the memorized standard difference or differences, in order to determine if the level of filling of said containers corresponds to the predetermined requirements.

According to another feature of this method, during the first calibration step, under said device are brought various standard containers the level of filling of which is considered sufficient, insufficient or excessive.

An additional feature consists in that, following the emission of a series of acoustic signals by said transmitting-receiving device is determined an average difference between the reflection signals corresponding to the mouth and corresponding to the level of content.

Furthermore, this invention relates to an acoustic transmitting-receiving device for the implementation of this method of control of the level of filling of containers.

The advantages of this invention consist in that it resorts to a method for the transmission and the reception of acoustic waves that, contrary to the optical methods restricted to the at least translucent containers, permit a control of the level of filling of any container, opaque, in particular.

Another advantage consists in that the method includes a learning (or calibration) step during which are detected, for various standard containers with a known level of filling, reflected acoustic signals from which are deduced standard differences characteristic of the level of filling of such a standard container.

During the control of the level of filling of a container, one proceeds to a simple comparison between these standard differences and the difference or differences determined based on acoustic signals reflected by the containers with an unknown level of filling.

According to another advantage, the fact of transmitting a series of acoustic signals and of determining an average difference between the reflection signals corresponding to the mouth and to the level of content, respectively, permits, advantageously, to take into consideration the fluctuations of the level of filling of a container the content of which is fluid.

A more detailed explanation of the invention is given in the following description relating to an embodiment given as an example and illustrated in the figures of the attached drawings.

### BRIEF DESCRIPTION OF THE SEVERAL VIEWS OF THE DRAWINGS

FIG. 1 is a schematic and partial view of an installation at the level of which it is proceeded to controlling the level of filling of containers according to the method of this invention;

FIGS. 2 and 3 are schematic views of reflection signals detected for standard containers the level of filling of which is considered excessive or insufficient, respectively;

FIG. 4 is a schematic view of reflection signals detected during the control of a container the level of filling of which is unknown.

### DETAILED DESCRIPTION OF THE INVENTION

The invention relates to the field of controlling the level of filling of containers in movement and relates, in particular, to a method consisting in ensuring such control.

Though, in the following part of the description, reference is made, in particular, to controlling the level of a liquid in a bottle, this invention is however not limited at all to it, and can, of course, be applied to any other type of container the content of which can be, itself, of any other type.

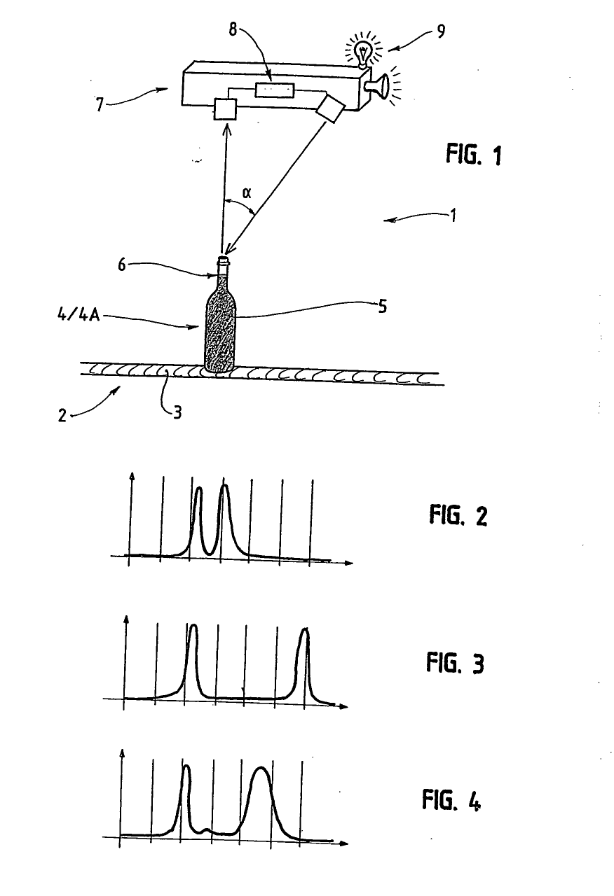

FIG. 1 corresponds to a schematic and partial view of an installation at the level of which it is proceeded to controlling the level of filling of containers according to the method of this invention.

Such an installation 1 is in the form of a conveyor device 2 including at least one conveyance chain 3 on which are arranged containers 4, in particular bottles, the content 5 of which (for example wine or similar) reaches a certain level 6 of filling. Such a conveyance chain 3 permits to ensure the transportation, in the form of a single-line stream, of these containers 4, in particular between a filling stand and a corking stand (not shown).

As shown in the same FIG. 1, this installation 1 includes, in addition, an acoustic transmitting-receiving device 7 arranged above the single-line stream of said containers 4.

This device 7 is designed capable, on the one hand, of transmitting acoustic signals SE in the direction of said containers 4 and, on the other hand, of receiving acoustic signals SR reflected by the same containers 4 and by their content 5.

For this purpose, such a device 7 includes, on the one hand, at least one transmitter of acoustic signals SE and, on the other hand, at least one receiver of acoustic signals SR. Such a transmitter and/or such a receiver are, preferably, formed of a transducer or the like, in particular of the ultrasonic type.

According to another feature of this device 7, said transmitter and said receiver are arranger above the conveyor 2, preferably shifted with respect to one another.

Thus, and as shown in FIG. 1, the beams of transmitted and reflected acoustic waves form between them an angle α, at the level of the location at which the control of the filling of a container 4 should be ensured.

A preferred embodiment consists in installing the receiver at the vertical of the location at which the control of the filling of a container 4 is ensured. The transmitter is shifted with respect to the vertical of this location. It is obvious that a reverse design can also be contemplated.

Said installation 1 includes, in addition, means 3 for processing the transmitted acoustic signals SE and/or the reflected acoustic signals SR.

Such processing means 8 can be associated to said transmitting-receiving device 7, in particular by being placed at a distance from the latter 7. However, a preferred embodiment consists in that this device 7 includes such processing means 8 as shown in FIG. 1.

Finally, this installation 1 includes means 9 designed capable of generating an alarm message, depending on the result of the control of the level 6 of filling of the containers 4 by their content 5, in particular when such containers 4 are insufficiently or excessively filled.

Such alarm means 9 are designed capable of being piloted by said processing means 8 mentioned above and can be of the visual (display screen for an appropriate message, light signal . . . ) and/or sound signal (buzzer, siren . . . ).

Such alarm means 9 can be associated to said transmitting-receiving device 7, in particular by being placed at a distance from the latter 7. However, a preferred embodiment consists in that this device 7 includes such alarm means 9 as shown in FIG. 1.

Another feature consists in that said acoustic transmitting-receiving device 7 is in the form of a casing, the latter receiving said processing means 8 and/or the alarm means 9.

As regards the method according to the invention, it consists in ensuring the control of the level 6 of filling of containers 4 by reflecting an acoustic signal SE transmitted by an acoustic transmitting-receiving device 7 arranged above a conveyor 2 including a conveying chain 3 on which said containers 4 are arranged, namely forming a single-line stream of containers 4.

This method is characterized in that:
during a first calibration (or learning) step, one or more standard containers 4A the level 6 of filling of which is known are brought under said transmitting-receiving device 7;
after the emission of one or more acoustic signals SE, the reflection signal or signals SR corresponding to the mouth of a standard container 4A as well as the reflection signal or signals SR corresponding to the level of content 6 of this standard container 4A are detected;
the difference or differences E between these reflection signals SR are memorized as standard differences EE; and
during the subsequent steps of control of containers 4 with an unknown level of filling 6, the difference or differences E of reflection signals SE, corresponding to the mouth and to the level 6 of the content 5, resulting from a signal or a series of acoustic signals SE transmitted by said device 7 are compared to the standard difference or differences EE memorized, in order to determine if the level 6 of filling of said containers 4 corresponds to the predetermined requirements.

According to another feature of the method of the invention, during the first calibration step, under said device 7 are brought various standard containers 4A the level 6 of filling of which is considered, according to the case, as sufficient, insufficient or excessive.

In fact, and according to a preferred embodiment, under said device 7 are brought, on the one hand, at least one standard container 4A the level 6 of filling of which is considered as insufficient and, on the other hand, at least one standard container 4A the level 6 of filling of which is considered as excessive.

Then one ensures, individually and for each one of these standard containers 4A, the emission of one or more acoustic signals SE and the detection, on the one hand, of the reflection signal or signals SR corresponding to the mouth of such a standard container 4A and, on the other hand, of the reflection signal or signals SR corresponding to the level 6 of the content 5 of this standard container 4A.

Then, for each one of these standard containers 4A are memorized as standard differences EE the difference or differences E between these reflection signals SR.

In this connection, it should be noted that each one of these standard differences EE is, in fact, characteristic of the level 6 of filling of a given standard container 4A (sufficiently, insufficiently or excessively filled) and therefore characteristic of a given level 6 (sufficient, insufficient or excessive) of filling.

It is, in particular, in comparison with these various standard differences EE that, during the control of a container 4 with an unknown level 6 of filling, that one determines whether this container 4 is sufficiently, insufficiently or excessively filled.

According to another feature of the invention, during the control of a container 4 with an unknown level 6 of filling, at first, the emission of a series of acoustic signals SE is proceeded to by said transmitting-receiving device 7. Following this emission, an average difference EM between the reflection signals SR corresponding to the mouth and the reflection signals SR corresponding to the level 6 of the content 5 is determined.

In fact, during the determination of such an average difference EM, the application of some mathematical method permitting to eliminate any wrong measure and related to the adopted procedure (fluid movement) is proceeded to.

In this connection, it should be noted that the determination of such an average difference EM permits, advantageously, to take into consideration the fluctuations of the level 6 of filling of a container 4 resulting from the fluidity of its content 5.

1. Method for controlling a level of filling of containers by reflecting an acoustic signal transmitted by an acoustic transmitting-receiving device arranged above a conveyer comprised of a conveying chain on which said containers are arranged, said method comprising the steps of:
bringing one or more standard containers under said transmitting-receiving device, during a first calibration step, wherein a level of filling of the containers is known;
detecting, after the emission of one or more acoustic signals (SE), reflection signal or signals corresponding to a mouth of a standard container as well as reflection signal or signals corresponding to the level of content of said standard container;
memorizing the difference or differences between reflection signals as standard differences; and
comparing the standard differences to determine if the level of filling of said containers corresponds to the predetermined requirements, during subsequent steps of control of containers with an unknown level of filling, the difference or differences of reflection signals, corresponding to the mouth and to the level of the contents, resulting from an acoustic signal or a series of acoustic signals transmitted by said device.

2. Method according to the claim 1, said detecting step further comprising:
during the first calibration step, bringing various standard containers under said device, wherein levels of filling of the various standard containers are determined as sufficient, insufficient or excessive.

3. Method according to claim 1, further comprising:
determining an average difference, following the emission of a series of acoustic signals (SE) by said transmitting-receiving device (7), between the reflection signals corresponding to the mouth and corresponding to the level of the contents.

4. Acoustic transmitting-receiving device arranged above a conveyor for implementation of a method of control of the level of filling of containers according to claim 1, said device comprising:
a conveying chain on which containers are arranged;
at least one transmitter of acoustic signals in a direction of said containers;
at least one receiver of acoustic signals reflected by said containers and by content of said containers; and
means for processing transmitted acoustic signals and/or the reflected acoustic signals, said processing means being associated to be able to generate an alarm message depending on results of control of the level of filling of the containers by their content.
